(19) United States
(12) Patent Application Publication
(10) Pub. No.: US 2012/0236302 A1
(43) Pub. Date: Sep. 20, 2012

(54) NANOSCALE VISOMETER DEVICE

(75) Inventors: Monika Rutowska, Cork (IE); Fatima C. Garcia Gunning, Cork (IE); Laura Horan, Cork (IE); Galvin Khara, Cork (IE)

(73) Assignee: University College Cork - National University of Ireland, Cork City (IE)

(21) Appl. No.: 13/422,500

(22) Filed: Mar. 16, 2012

(30) Foreign Application Priority Data
Mar. 18, 2011 (GB) 1104547.3

(51) Int. Cl. G01J 3/44; G01N 11/06

(52) U.S. Cl. 356/301; 73/54.08

(57) ABSTRACT

A nano viscometer device suitable for determining the concentration of a solute within a fluid sample preferably includes a hollow core Photonic Crystal Fibre (HC-PCF) acting as a capillary tube having a core and means for filling the capillary tube with a fluid sample. Light is preferably guided light into the HC-PCF and detected exiting the tube. The rate at which the capillary tube is filled with the fluid is optically measured based on the light to determine the viscosity of the fluid to calculate the concentration of a solute. The preferred capillary viscometer is capable of measuring the viscosity of nano-litre quantities of a sample fluid. On one example, the preferred viscometer makes use of HC-PCF for the detection of glucose dissolved in nano water, demonstrating that HC-PCF can be used for continuous monitoring of glucose levels within blood plasma.

### FIELD OF THE INVENTION

The invention relates to a nano viscometer device. More specifically, the invention relates to a capillary viscometer device for analysing biological and non-biological liquid samples and methods for analysing the same.

### BACKGROUND TO THE INVENTION

Diabetes and the management of glucose levels within the blood is a problem with effects felt worldwide. The human body naturally releases insulin to maintain the whole blood glucose level below 7.6 mmol/L after the ingestion of food, and is usually much lower during fasting. In patients with diabetes, this release of insulin is impeded, causing possible nerve ending damage, cardiovascular disease, kidney failure, and in more extreme cases amputation, stroke and death.

Current methods for the determination of glucose levels rely on the chemical reaction of glucose to gluconolatone catalysed by glucose oxidase or other enzymes such as glucose dehydrogenase. Commercially available glucose monitors have an accuracy that tend to have a 20% error rate compared to lab diagnosis, as specified by the International Organisation for Standardisation (ISO). These error margins assume a perfect theoretical system. This wide discrepancy in results could lead to the misdiagnosis of elevated blood sugar levels in patients that are undergoing home monitoring. In daily use, errors can increase due to mis-calibration, testing-strip abnormalities, heat, and residue on the fingertips or site of testing. High error rate leaves patients vulnerable to an unreliable measurement system.

Optical fibre sensing is a field that has attracted a large research interest since the cheap production of standard optical fibres. Important physical parameters can be determined with a high sensitivity using the evanescent field, as they allow for continuous measurement without electrical interference, and it is in this area that has seen a rapid growth in research, due to its diverse applications. In standard optical fibres, utilisation of the evanescent field, outside of the waveguides core, requires the modification of the structure of the fibre. Currently available nano-litre viscometers require a complex structure of channels and analysis to determine the viscosities of liquids. Others require a constant monitoring of the liquid-air interface via CCD camera as the liquid flows through micro-channels via capillary action. Other optical methods aim to detect glucose using florescence measurements to detect enzymatic reactions. Examples of prior art viscometer devices are disclosed in WO03/058210, Rheologics Inc, GB 1 426 824, Societe Francaise D'Instruments, WO2008/097578, Kensey, and GB 924688, Exxon Research. However, such devices and methods are complex and prone to significantly erroneous measurements.

It is an object of the present invention to provide a nano-litre capillary viscometer to overcome at least some of the above-mentioned problems.

### SUMMARY OF THE INVENTION

According to the present invention there is provided, as set out in the appended claims, a nano viscometer device suitable for determining the concentration of a solute within a fluid sample, said device comprising:
a hollow-core Photonic Crystal Fibre (HC-PCF) configured as a capillary tube having a core and adapted for filling the capillary tube with a fluid sample;
a light source for propagating light through the fibre core;
means for detecting the light exiting the tube, wherein the rate at which the capillary tube is filled with the fluid is optically measured from said light source to determine the viscosity of the fluid to calculate the concentration of solute.

In one embodiment the capillary tube is a hollow core photonic crystal fibre (HC-PCF). In another embodiment several HC-PCF's can be used. The technical problem that has been solved is the provision of a capillary viscometer capable of measuring the viscosity of nano-litre quantities of a sample fluid. The viscometer of the present invention makes use of HC-PCF for the detection of concentrations of glucose dissolved in nano water, demonstrating that HC-PCF can be used for the continuous monitoring of glucose levels within blood plasma. Such analysis of determining the specific parameters of viscosity and surface tension of liquids has, to the knowledge of the inventors, not been performed before using HC-PCF. In HC-PCF, the unique structure allows the guidance of light in air, and therefore the full optical field can be accessed without modification of the fibre. Due to the unique microstructure, light is guided in the core (even when hollow) through photonic band gap effect (PBG). As it is hollow, it allows samples to be introduced within its hollow core and the hollow surrounding capillaries, enabling a shift in the PBG, which is characterised by a wavelength shift. What makes the HC-PCF fibres so appealing is that they allow the insertion of a sample into the core and cladding of the fibre, giving a large overlap between liquid sample and optical field, compared with standard optical fibre that would rely on the evanescent field alone.

Nano-litre viscometers have a wide range of uses in the analysis of biological fluids and chemical detection in pharmaceutical and medical industries, amongst others. Typically their concept of performance is based on rotating cone and/and plate, or else by analysing sideways the meniscus position inside a capillary. The present invention provides a viscometer device that is small, simple in design, and low cost for the determination of, for example, glucose concentration in nano-litre samples of blood plasma. Standard glucose meters require a small droplet of blood, about one micro litre in volume to determine glucose levels. Reducing this required volume to nano-litres potentially reduces the discomfort the patient needs to endure.

The nano capillary viscometer is compact and simple, and potentially low cost. It is the ideal candidate to be used remotely or at point-of-care. Another advantage is the possibilities to work at high temperatures, as silica glass capillaries will melt between 800 and 1200° C., enabling sterilisation. The invention also does not require U-shaped geometries. Liquid samples of less than 1 μL can be measured with an accuracy better than 10⁻⁴ for viscosity.

The benefits of creating a viscometer from the capillaries of the HC-PCF is that, unlike other micro-channel viscometers, the design of the HC-PCF is not complex, and, although possible, it does not require constant monitoring of the liquid rise through the channels via CCD to calculate the velocity or the pressure changes.

In one embodiment the light source comprises a laser source, for example a helium-neon laser.

In one embodiment there is provided means for guiding the light into the hollow core PCF.

In one embodiment there is provided a nano-positioning stage to align the tube with the light source.

In one embodiment the fluid sample is a blood plasma.

In one embodiment the solute is glucose.

In one embodiment the means for detecting light exiting the capillary tube is a photodiode detector.

In one embodiment there is provided a charge couple device (CCD) image sensor to aid alignment of a core of the capillary tube to the axis of the light source.

In one embodiment the diameter of the fibre core is between 8 μm and 12 μm.

In one embodiment there is provided a second light source, adapted to allow Raman backscattering of the filled fibre in order to identify the fluid sample from Raman peaks detected. The detected Raman peaks are representative of fructose or glucose levels in the fluid sample.

In another embodiment there is provided a method for determining the concentration of a solute in a sample using a capillary viscometer, the method comprising the steps of:
(a) applying the sample to the reservoir;
(b) applying optional over-pressure means to the reservoir to move the sample to HC-PCF;
(c) detecting the changes in propagation of light through HC-PCF and time as the tube fills with sample; and
(d) determining the concentration of the solute in the sample from the rate at which the tube fills with said sample.

In one embodiment there is provided the step of detecting the changes in propagation of light is determined by changes in output power from the photodiode detector.

In one embodiment the over-pressure means comprises a syringe pump or head syringe.

In one embodiment the means for identifying the sample is a Raman scattering setup system.

It will be appreciated that by measuring the changes in optical guidance while the core and capillaries of the fibre are filled, it is possible to determine accurately the flow rate (less than milliseconds, depending on the implementation), and therefore calculate important parameters, such as viscosity and surface tension. For glucose monitoring, the ratio of viscosity to surface tension is dependent on the glucose concentration on blood plasma, for example, enabling an accurate glucose monitor sensor. The advantages of the invention includes its size, as it is only dependent on the optical fibre length (about 10 cm), but it can be as practical as a pen, and the accuracy that it can measure flow rates will depend mainly on the specifications of the photo-diode, which, in turn, will influence the costs.

### BRIEF DESCRIPTION OF THE DRAWINGS

The invention will be more clearly understood from the following description of an embodiment thereof, given by way of example only, with reference to the accompanying drawings, in which:—

FIG. 1a illustrates a commercially available HC-PCF 1060 from NKT Photonics, viewed under an optical microscope (x50), showing a periodic lattice of capillaries;

FIG. 1b illustrates the theoretical prediction for the time taken to fill the core of a HC-PCF with diameter 10 μm for a given length;

FIG. 1c illustrates the band gap shift for the HC-PCF 1060 of FIG. 1a;

FIG. 2 illustrates a capillary viscometer setup according to a preferred embodiment of the invention;

FIG. 3 illustrates that as the HC-PCF 1060 used in the device of FIG. 2 fills with liquid, there is change in light guidance as shown by an increase in power (voltage); inset shows the CCD images with evidence of propagation changes;

FIG. 4 illustrates (a) Experimental data for glucose in water batches measured with different temperatures plotted to theoretical predictions, and (b) Graph indicating the two batched of samples measured at 25° C. and 26° C.;

FIGS. 5 to 7 illustrates evidence of photonic bandgap shift when filled with a liquid of refractive index 1.33;

FIG. 8 illustrates an adapted nano viscometer setup of FIG. 1 to align, measure the average velocity and analyse the Raman backscattering, according to another embodiment of the invention;

FIG. 9 shows a typical result for the Raman backscattering of solutions with different sugars: fructose and glucose, indicating their unique features obtained for nano viscometer of FIG. 8.

### DETAILED DESCRIPTION OF THE DRAWINGS

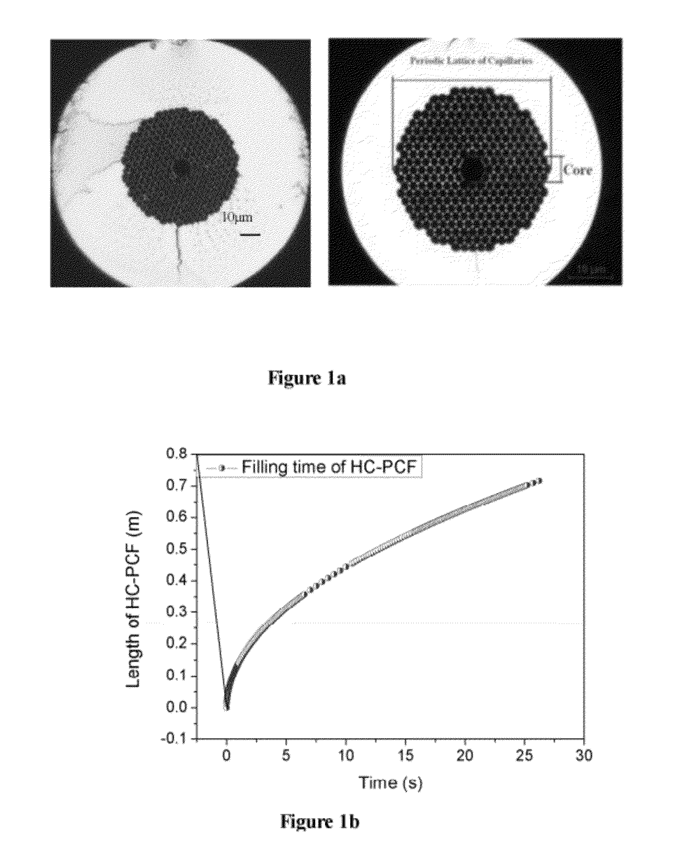

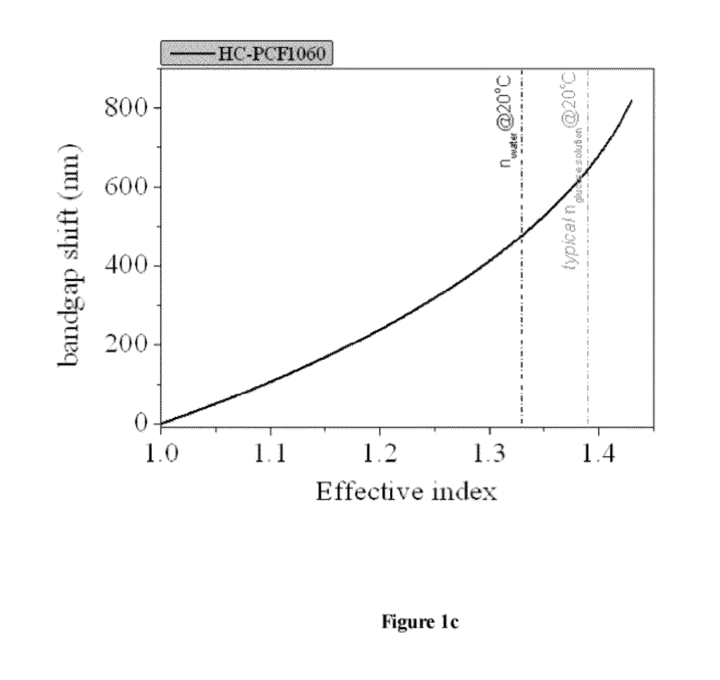

Before describing the viscometer of the invention in detail it is necessary to give some background on HC-PCF fibres. The development of HC-PCF has changed the course of optical fibre sensing in the past decade since their first creation. HC-PCFs are optical fibre waveguides that consist of a periodic microstructure of hollow capillaries, as shown in FIG. 1a, and light is guided by a phenomena called Photonic Band Gap (PBG) effect. The microstructure cladding contains thin-wall silica capillaries that surrounds an extra-large hole in the centre, which usually is formed by removing seven capillaries from the stack during fabrication process. The core size and shape controls the particular number of guided modes. Hence, only certain frequencies fall within the bandgap and are guided, other frequencies leak out of the core. These novel fibres have been applied to the areas of gas-, temperature- and bio-sensing. In optical fibre sensing, the refractive index change is usually monitored and tend to contain important information regarding the sensing unit. In the present invention, the change in light propagation, due to the filling of the capillaries with liquid, is used to determine the viscosities of liquids, such as for example glucose solutions.

The HC-PCF used can be for example a commercially available HC-PCF-1060, manufactured by NKT Photonics A/S, as shown in FIG. 1a. It will be appreciated other types of HC-PCF can be used. HC-PCF is a reliable source of micro-capillary structures that also display unique light guiding properties. Liquid samples are inserted into the capillaries, and the flow through the short lengths of fibre is monitored to determine the viscosity and concentration of glucose, for example. HC-PCF allows the insertion of liquids into the hollow capillaries via the capillary effect due to the contact angle between the liquid and the silica walls, and surface tension of the liquid. The determination of the flow of the liquid through the capillaries, in particular focussing on the core of the fibre, allows the calculation of the viscosity of the nano litre liquids.

The core of the fibre used to demonstrate the principle has a typical diameter of 10±1 μm, which is on the same scale range of a micro viscometer. Due to the dimensions of the core of the HC-PCF, surface tension becomes the dominant force in the rise of liquid through the capillaries, and the flow through the core can be analysed to calculate the viscosity of the fluid. This allows the viscometer to pick up minute changes in the concentration of glucose within the sample, due to the strong reliance of the viscosity of the sample on its surface tension and temperature.

The flow of liquid through a short length of 10-20 cm of HC-PCF is detectable and can be analysed as per the following equations as outlined in K. Nielsen et al. (“Selective Filling of Photonic Crystal Fibres”, J. Opt. A: Pure Appl. Opt. 7 (2005) L13-L20). It will be appreciated that a range of fibres can be used. Fibres within a range of 10-20 cm were considered in order to give an appropriate level of accuracy, and the lengths were kept below 20 cm as a precaution to temperature fluctuations from external conditions.

An equation, which takes into account the sum of forces acting on fluid flow through the capillary tube can be used to determine the viscosity of the fluid sample, assuming laminar flow of a Newtonian fluid, no overpressure nor effects by gravity:

$$L ( t ) = \sqrt{( \frac{A}{{B}^{2}} exp ( - Bt ) + \frac{At}{B} - \frac{A}{{B}^{2}} )}$$

$$where$$

$$A = \frac{4 σ cos θ}{ρ a}$$

$$and$$

$$B = \frac{8 μ}{ρ {a}^{2}}$$

In the equation above L(t) is the length of fibre being filled within a certain time t, and A and B are constants dependent on the surface tension σ, the incident angle θ, density ρ, the core radius a, and viscosity μ. The above data therein describes the filling of HC-PCF in time, as shown in FIG. 1b assuming the liquid being water only. To utilise the capillary effect to determine the viscosities of liquids, a detection system must have the ability to measure accurately the point in time when the liquid enters the core (t=0), and the point when the core is completely filled (t=t_{f}). By applying the capillary filling theory, as above, one can measure the average velocity v that the liquid fills a given fibre length L_{c} during time t_{f}, and determine the ratio between viscosity and surface tension to monitor liquid parameters, that is dependent on the fibre parameters alone, as:

$$\frac{μ}{σ} = \frac{a}{2 {vL}_{c}}$$

From experimental results, the inventors found that repeatable results for water are only possible after several fillings of the HC-PCF, creating a thin film coating on the walls of the hollow capillaries allowing unrestricted movement of water through the capillaries. Solvents and other liquids that do not display the hydrophilic and polar properties of water will fill in a repeatable manner, as predicted by the theory, without the need for multiple filling. Adding these solvents in small concentrations to water could overcome the multiple filling problems and hydrophilic properties of water.

The unique microstructure of the HC-PCF allows light to be guided within the air core by the PBG effect. The introduction of liquids to all hollow capillaries of the HC-PCF changes the refractive index contrast, while still allowing guidance by the PBG. In particular, when the low index material n₂ of the HC-PCF is varied while the high index n₁ remains unchanged, so that the initial index contrast N₀=n₁/n₂ becomes N, any bandgap found originally at a wavelength λ₀ will shift to a new wavelength λ given by:

$$λ = {λ}_{0} \sqrt{\frac{( 1 - \frac{1}{{N}^{2}} )}{( 1 - \frac{1}{{N}_{0}^{2}} )}}$$

Depending on the refractive index of the liquid and choice of HC-PCF, the bandgap can be shifted to guide light of most visible wavelengths, below the initial allowed waveband, as shown in FIG. 1c for a HC-PCF 1060, i.e., with initial bandgap λ₀ at 1060 nm, n₁˜1.45, n₂˜1 (before filling). However, if only the core is filled, the guiding mechanism is not longer by PBG, but a phenomenon called index-like guiding, due to the core having a higher refractive index than the surrounding air capillaries, with an effective index of about 1. As a sensor, it was assumed that different concentrations of glucose solutions will have different values of refractive index, viscosity and surface tension. Therefore, this would affect the filling time of the HC-PCF and the light guiding properties due to the shift in bandgap, where a fibre was allowed to be fully filled with a water solution, and the effects on guidance was observed in the insets.

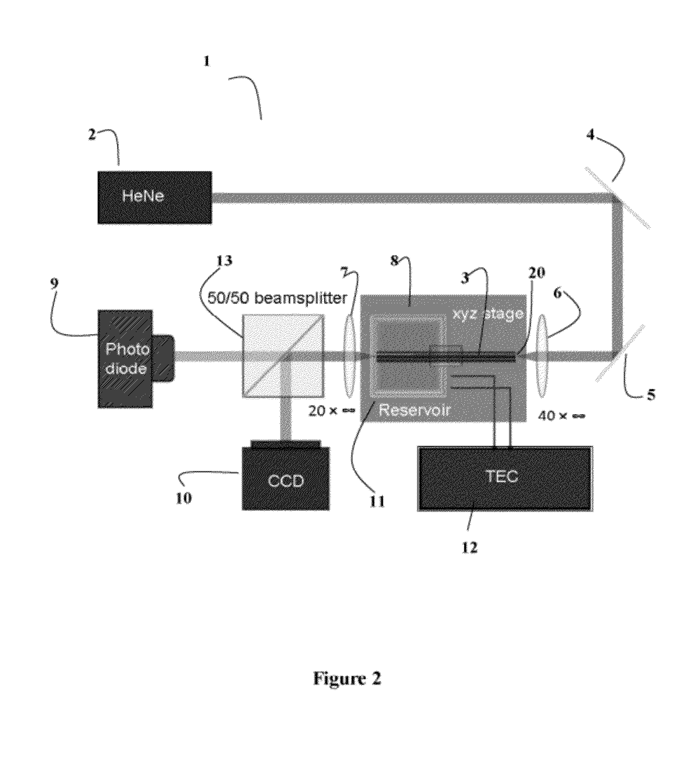

The optical implementation to demonstrate the present invention of a nano-litre viscometer is shown in FIG. 2 according to one embodiment, indicated generally by reference numeral 1. The results shown here investigate the dependency of concentration of glucose in nano water, but not limited to. Light of 633 nm is emitted from a source 2 and guided into a core 20 of a HC-PCF 3 (also referred to as a “fibre”) using beam steering mirrors 4,5 and infinity correction lens 6,7 and an optional nanopositioning xyz stage 8 used in this demonstration. Exiting light from the HC-PCF is collimated to a photodiode detector 9 and a charge coupled device (CCD) image sensor 10 by a 50/50 beamsplitter 13 to aid alignment of the core of the HC-PCF to the laser axis. Liquid is inserted into the hollow core 20 via a reservoir 11, which is kept at a constant temperature ±0.1° C. by a combined peltier heating element and temperature controller 12. All results were taken with liquids kept at 25.2±0.1° C., unless otherwise stated.

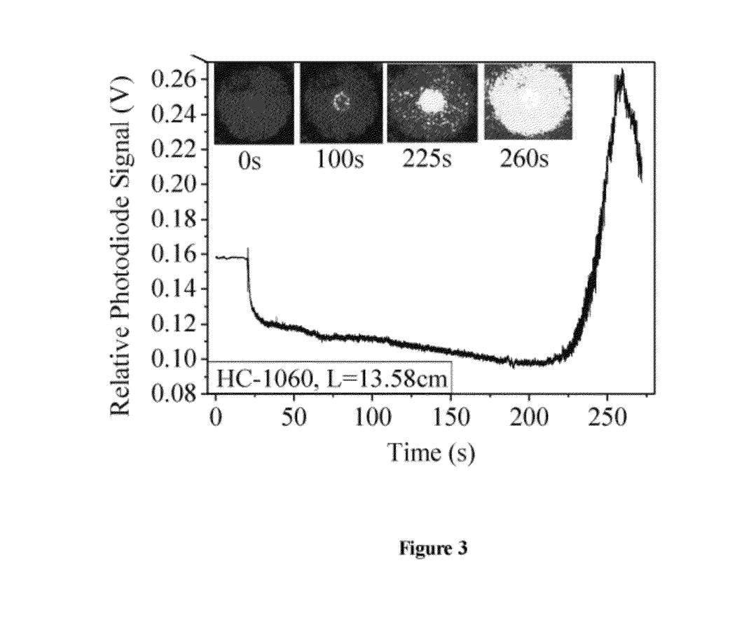

As the HC-PCF 3 (in this case, HC-PCF 1060) fills with liquid, the light propagation changes, and this change can be seen from the photodiode as a change in power (or current), as shown in FIG. 3. This change in power can be explained after considering how light propagates though a HC-PCF while filling. When liquid is added to the reservoir 11, it may scatter or absorb light, so that only a small portion will be sent to the photodiode. As the liquid travels up through the HC-PCF 3, the core 20, which has a larger radius to the capillaries, will fill faster, allowing light to be guided by the index-like guiding effect, as at that point the index in the core 20 will be larger than the refractive index of the surrounding microstructure cladding, of an effective value close to 1 (or significantly less than the liquid). Hence, the spectrum of guiding wavelengths becomes wide, and therefore any light source in this new wavelength window may be used as a source. However, it is recommended to use the visible range or near-infra red region due to strong water attenuation for long wavelengths. Once the capillaries of the HC-PCF 3 begin to fill, there will be a portion of the fibre 3 that will be completely filled with liquid, allowing guidance by the PBG in this section of fibre 3. The filling of the core 20 can be seen as a rapid increase in power from the photodiode, as seen in FIG. 3.

Measurements were taken using nano water and glucose D-(+)-Glucose, anhydrous 96% purchased from Sigma-Aldrich to demonstrate the principle. These are combined to create the solutions of glucose water of concentrations that are found in blood plasma that are normal, hypoglycemic and hyperglycemic. This falls within a range of 4.6 mmol/L to 11 mmol/L. Blood plasma was chosen to be synthesized and analyzed as it is a Newtonian fluid, reducing the complexity of analysis, and as blood plasma consists of 90% water, it allows the transmission of light, and can be easily synthesized in lab conditions.

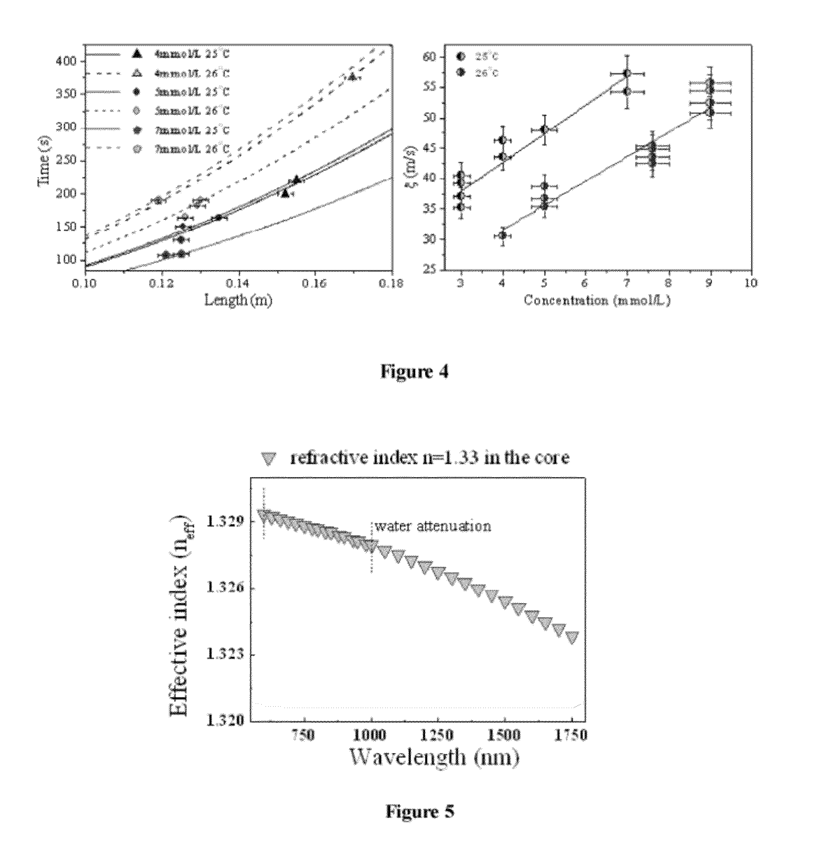

Results show that there is a detectable difference between the ratio of viscosity versus surface tension for each of the solutions tested and detected by the photodiode 9, which can be calculated by using the length of the fibre 3 used and the time taken to fill the core 20 (FIG. 4). FIG. 4 illustrates (a) Experimental data for batches measured with different temperatures (scatter points) plotted to theoretical predictions (lines). (b) Graph indicating the two batched of samples measured at 25° C. and 26° C.

All lengths of fibre 3 fill in a repeatable manner for each different concentration of glucose and nano water used, suggesting that the addition of such a minute amount of glucose overcomes the tendency of water to be hydrophilic to the silica walls of the capillaries. Error rates are less than 10%, and are typically approximately 3% for low concentrations, as shown in Table 1.

TABLE 1
Data for glucose concentration determination.

| | | |
|---|---|---|
| | Average ratio of | Standard |
| Concentration | Viscosity/Surface Tension | Deviation |

| | | | |
|---|---|---|---|
| 4 | mmol/L | 0.0221 | 0.0005 |
| 7.6 | mmol/L | 0.0228 | 0.0006 |
| 9 | mmol/L | 0.0191 | 0.0008 |
| 11 | mmol/L | 0.0240 | 0.0017 |

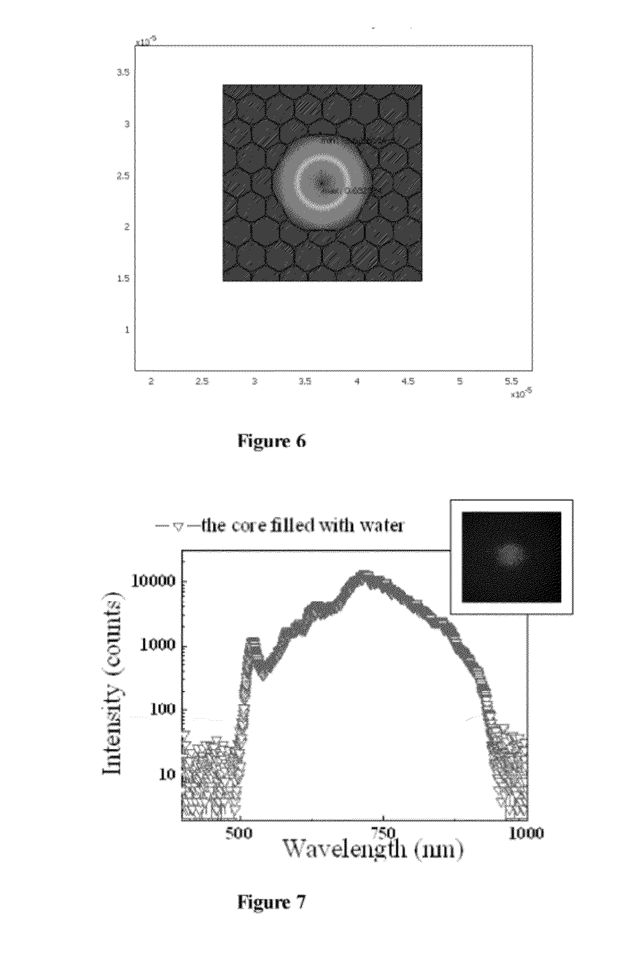

FIGS. 5 and 6 illustrates simulation results where the effective index shows that for the material with refractive index 1.33 we should find the propagation of particular wavelengths close to value of the effective index (axis Y). FIG. 7 shows the wide transmission window achieved experimentally when only the core capillary was filled with water, resulting in an index-like guiding effect.

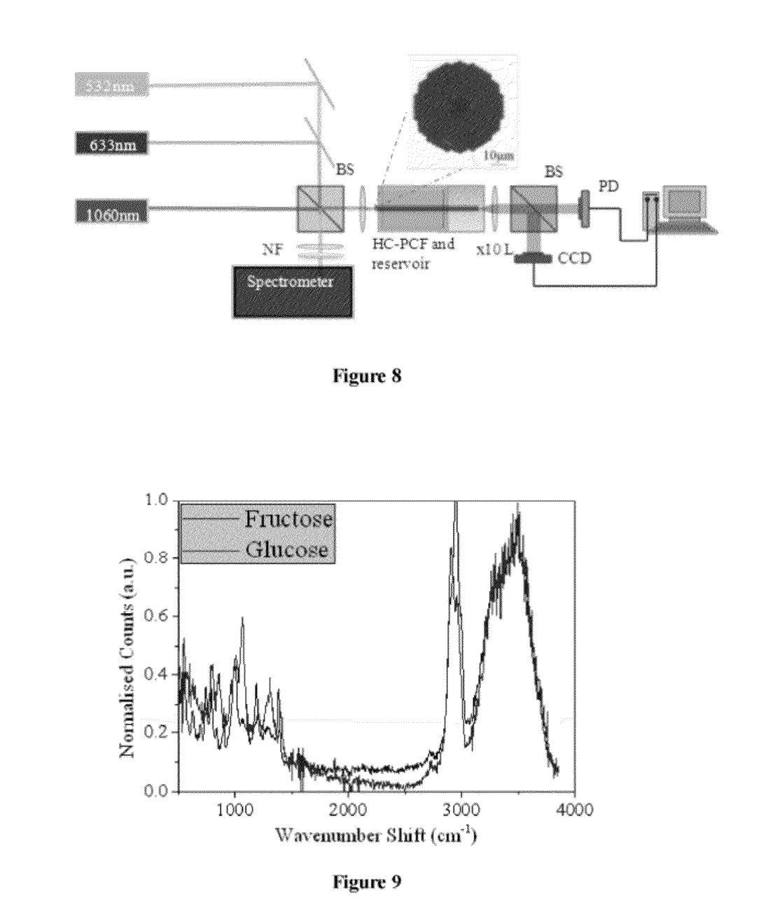

FIG. 8 illustrates another embodiment of the invention, similar to FIG. 2, where multiple light sources can be provided to assist with the optical alignment of the fibre (exemplified as 1060 nm source for HC-PCF 1060). A second source is adapted to measure the average velocity with a laser wavelength that falls within the propagation window once core is filled with liquid (here as 633 nm). A third source, for example a pump laser at 532 nm, is adapted to allow Raman backscattering of the filled fibre in order to identify the liquid in question. For example a spectrometer is used and resultant curves represented in FIG. 8 for two different saccharides can be readily identified.

In addition, it will be appreciated that a group of narrow band filters and an inexpensive photo detector could be used to identify the presence of certain compounds.

The inventors have shown that HC-PCF can be used as a detector to determine the viscosity of glucose and distilled water samples, leading to the calculation of the glucose concentration within distilled water. Other uses for this HC-PCF nano liter viscometer of the present invention is the analysis of biological fluids, and chemicals. Surface tension of blood plasma and other biological fluids is an indicator of diseases. Alcohols, solvents and other non-polar liquids can be detected and their parameters determined. Propan-1-ol concentration in distilled water can be measured. Nano viscometers are particular important for chemical detection in pharmaceutical, polymer industries. Usually their viscometer measurement concepts are based on a cone and plate or capillary viscometer set-up, which do not perform within the nano-litre range. The detection of trace nitrates and other chemicals within urban water supplies could be an extended application for this invention.

In the specification, the term “HC-PCF” should be understood to mean hollow core photonic crystal fibres which are optical waveguides that consist of a periodic microstructure of hollow capillaries, and allow the guidance of light by the photonic band gap (PBG) effect (that is, confining light by band gap effects within the core capillary). Such fibres have a cross-section (normally uniform along the fibre length) microstructured from two or more materials, most commonly arranged periodically over much of the cross-section, usually as a “cladding” surrounding a core where light is confined. For example, the fibres may consist of a hexagonal lattice of air holes in a silica fibre, with a hollow core at the centre where light is guided.

In the specification, the term “nanopositioning xyz stage” should be understood to mean a platform or nanopositioner which can operate in one, two, or three dimensions. The x- and y-axes refer to motion in the plane of the nanopositioner and the z-axis is vertical (up and down) motion. Rotations about the x-, y-, and z-axes are termed gamma (γ), theta (θ) and phi (φ) motions, respectively.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A viscometer device suitable for determining the concentration of a solute within a fluid sample, said device comprising:
a hollow-core Photonic Crystal Fibre (HC-PCF) configured as a capillary tube having a core and adapted for filling the capillary tube with a fluid sample;
a light source for guiding light into the tube; and
means for detecting the light exiting the tube, wherein the rate at which the capillary tube is filled with the fluid is optically measured from said light source to determine the viscosity of the fluid to calculate the concentration of a solute.

2. A viscometer device according to claim 1, wherein the capillary tube is a hollow core photonic crystal fibre.

3. A viscometer device according to claim 1, wherein the light source comprises a laser, for example a helium-neon laser.

4. A viscometer device according to claim 1, wherein the light source comprises at least one of: a semi-conductor laser, photodiode light source, LED or a collimated light source.

5. A viscometer device according to claim 1, comprising means for guiding the light into the capillary tube.

6. A viscometer device according to claim 1, comprising means for guiding the light into the capillary tube wherein said means for guiding the light is an infinity correction lens.

7. A viscometer device according to claim 1 comprising a nano-positioning stage to align the tube with the light source.

8. A viscometer device according to claim 1 wherein the fluid sample is a blood plasma.

9. A viscometer device according to claim 1 wherein the solute is glucose.

10. A viscometer device according to claim 1 wherein the means for detecting light exiting the capillary tube comprises a photodiode detector.

11. A viscometer device according to claim 1 comprising a charge couple device (CCD) image sensor to aid alignment of a core of the capillary tube to the axis of the light source.

12. A viscometer device according to claim 1 wherein the diameter of the core is between 8 μm and 12 μm.

13. A viscometer device according to claim 1 comprising a second light source, adapted to allow Raman backscattering of the filled fibre in order to identify the fluid sample from Raman peaks detected.

14. A viscometer device according to claim 13 wherein detected Raman peaks are representative of fructose or glucose levels in the fluid sample.

15. A method for determining the concentration of a solute in a sample using the viscometer device of claim 1, the method comprising the steps of:
(a) applying the sample to the reservoir;
(b) applying over pressure means to the reservoir to move the sample to the capillary tube;
(c) detecting the changes in propagation of light through the tube as the tube fills with sample; and
(d) determining the concentration of the solute in the sample from the rate at which the tube fills with said sample.

16. A method according to claim 15, wherein detecting the changes in propagation of light is determined by changes in power output from the photodiode detector.

17. A method according to claims 15, wherein the pressure means comprises a head syringe.
